(19) United States
(12) Patent Application Publication
(10) Pub. No.: US 2007/0125300 A1
(43) Pub. Date: Jun. 7, 2007

(54) Wallpaper pasting machine

(76) Inventor: Emmanouel C. Marinos, Hanover Park, IL (US)

Correspondence Address: GREENBERG & LIEBERMAN, LLC, 2141 WISCONSIN AVE, N.W., SUITE C-2, WASHINGTON, DC, 20007, US

(21) Appl. No.: 10/575,415

(22) PCT Filed: Oct. 8, 2004
(86) PCT No.: PCT/US04/33481

§ 371 Date: Apr. 10, 2006

(30) Foreign Application Priority Data
Oct. 8, 2003 (US) 10605562

(51) Int. Cl. B05C 1/00

(52) U.S. Cl. 118/216; 118/200

(57) ABSTRACT

A wallpaper pasting device that unrolls wallpaper from a paper roll (40), as well as measures wallpaper as it is dispensed using counter (50). Adhesive is applied via the present invention using first adhesive swiper (70) and second adhesive swiper, so that the wallpaper is ready to be cut and installed on a wall. A single user can thus prep wall paper for wall mounting.

### FIELD OF THE INVENTION

The present invention is a machine that assists in wallpaper pasting. More specifically, it is a device for dispensing, measuring, and disposing adhesive on wallpaper.

### BACKGROUND OF THE INVENTION

Wallpaper pasting is commonplace in both residential and commercial settings. The large strips of wallpaper that are used for covering commercial sized areas, especially, are difficult to work with for a variety of reasons.

Usually installing with wallpaper demands at least two men working together. Essentially, one man has to unroll the wallpaper while another man has to hold the end of the wallpaper. Additionally, one of the men has to measure the proper length of wallpaper being dispensed. Furthermore, one of the men has to apply adhesive to the wallpaper. Moreover, one of the men has to ensure that the adhesive is not applied to the wallpaper too excessively. Also, it is impossible to measure a length of wallpaper greater than the dimensions of the room in which the men are working; that is, measuring a 12 foot-long strip of wallpaper is impossible if the room in which the men are working is only 8 feet-long.

Japanese Patent Application no. 10376639 issued to Yasuhiro on Mar. 12, 1998 shows an automatic wallpaper paster. Yasuhiro's invention is unlike the present invention because it does not have a means to measure the amount of paper pasted, and it does not allow the user to determine the thickness of the paste on the paper, or easily change the type of paste used.

Japanese Patent no. 04083151 issued to Takuya on Mar. 5, 1992 shows an assisting device for wallpaper sheet applying work. Takuya's invention is unlike the present invention because it attaches the wall paper to the wall by means of a dolley, and it does not provide a means of measuring the paper to which glue has been applied.

Japanese Patent application no. 10222257 issued to Yasuhiro on Jun. 6, 1998 shows an automatic wallpaper gluing machine. Yasuhiro's invention is unlike the present invention because it does not have a means of measuring the amount of wallpaper to which paste has been applied, it has no means of cutting the wallpaper, and it requires an electrical connection to operate.

Japanese Patent application no. 11356604 issued to Masaki, et al., on Dec. 15, 1999 shows a wallpaper pasting machine. Masaki's invention is unlike the present invention because it does not have a means of determining the amount of paper that paste has been applied to and it does not provide a means to cut off the paper when it has reached a particular length.

Japanese Patent application no. 10343989 issued to Ko on Mar. 12, 1998 shows a wallpaper pasting machine having glue replenishing device. Ko's invention is unlike the present invention because it requires a motorized pump and it does not have a means of measuring the wallpaper as it is applied with adhesive.

Japanese Patent application no. 11376912 issued to Jun, et al., on Dec. 20, 1999 shows a automatic wallpaper pasting machine. Jun's invention is unlike the present invention because the paper is pasted in such a manner that the paper leaves the box at an angle wherein the pasted side faces downward. Additionally Jun's invention does not have a means to measure the amount of paper that has paste applied, or a means to cut the paper from the pasting machine.

Japanese Patent application no. 2000374041 issued to Genzo, et al.,on Aug. 12, 2000 motor operated pump for paste and automatic wallpaper pasting machine. Genzo's invention is unlike the present invention because it requires a pump operated by a cam mechanism to distribute the paste to the paper. It does not provide a means to cut the paper, or a means to measure the amount of paper dispensed. Additionally the pump distributes a set amount of paste to each section of paper, whereas the present invention allows the user to control the amount of paste added to each piece of wallpaper without reseting a pump.

Japanese Patent application no. 20000296967 issued to Genzo, et al., on Sep. 28, 2000 shows a wallpaper pasting machine with liquid paste feeding pump. Genzo's invention is unlike the present invention because it requires a separate paste container, a separate paste pump, it does not provide a means to measure the wall paper with adhesive, and does not provide a means to cut the paper to a desired length.

Japanese Patent application no. 2000300414 issued to Genzo, et al., on Sep. 29, 2000 shows a allpaper pasting machine and wallpaper cutting apparatus. Genzo's invention is unlike the present invention because it does not provide a means to measure the amount of wallpaper which has adhesive applied, so the user may only paste and cut the correct or desired amount of paper.

Japanese Patent application no. 2000242855 issued to Yasushi on Oct. 8, 2000 shows a wallpaper and method for adhering the same. Yasushi's invention is unlike the present invention because it has a backing conventional to a self laminate sheet, it does not have a means for applying paste to wallpaper, and does not provide a means for measuring wall paper or cutting wallpaper with adhesive to an appropriate length.

Japanese Patent application no. 2000375464 issued to Genzo, et al., on Nov. 12, 2000 shows an automatic wallpaper pasting machine. Genzo's invention is unlike the present invention because it requires a container of paste attached to a pump feeding into a paste tub.

Therefore a need has been established for a device for dispensing wallpaper capable of being operated by a single man. Additionally, it would be desirable to have a wallpaper dispensing device which permits measurement of the wallpaper being dispensed so proper lengths of wallpaper can be matched to wall surfaces. Even more, it would be very advantageous to have a device that permits dispensing of a length of wallpaper exceeding the dimensions of the room in which the wallpaper is being dispensed. There is also a need for a device that assists in the proper distribution of adhesive across wallpaper.

### SUMMARY OF THE INVENTION

The present invention is a box-like device that dispenses wallpaper in a way that saves both time and money. Capable of being operated by a single person, the present invention holds a roll of wallpaper at one end so that wallpaper is held essentially flat across the present invention's bottom. Two boards form a chamber that contains adhesive, and the wallpaper moves across the present invention's bottom, underneath the chamber that contains adhesive. The amount of adhesive disposed on the wallpaper can be controlled. A rolling measure indicates how much wallpaper is actually being dispensed from the roll. The present invention then cuts the wallpaper so that it can be applied to a wall.

The present invention also allows the user to dispense wallpaper, and then fold the wallpaper back onto itself as wallpaper continues to dispense; thus, permitting a single user to dispense a long sheet of wallpaper that already has adhesive. This is critical because it means that a single user can work alone to wallpaper an entire room if desired. Thus, the present invention allows a single user to take wallpaper from the wallpaper roll and prep it for wall application.

### BRIEF DESCRIPTION OF THE DRAWING(S)

FIG. 1 shows a front perspective view of the present invention.

FIG. 2 shows a side perspective view of the present invention.

### DETAILED DESCRIPTION OF THE PREFERRED EMBODIMENT(S)

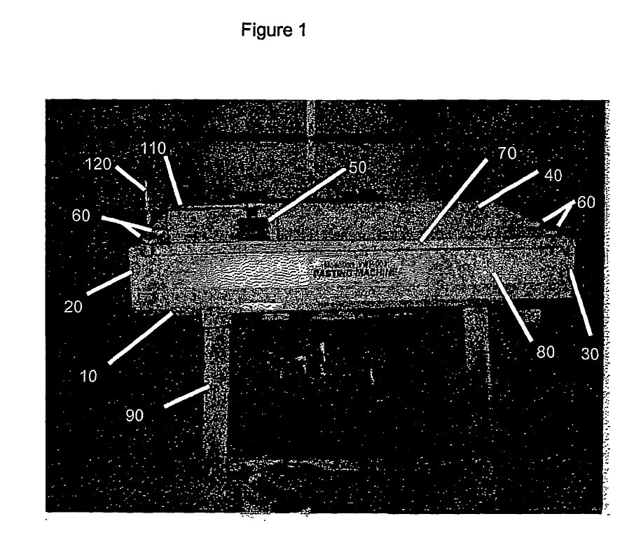

In FIG. 1, a front perspective view of the present invention is shown. This is the user's view if the user is kneeling at eye level at the dispensing end of the present invention. The bottom (10) of the invention is shown, as well as the left side (20) and right side (30). The wallpaper roll (40) is toward the rear of FIG. 1, with the counter (50) partially obstructing the view of the wallpaper roll (40). Adjustment pieces (60) are disposed near left side (20) and right side (30) to control the height of a first adhesive swiper (70) and a second adhesive swiper (80). The bottom (10) of the present invention is elevated upon a conventional workbench (90) for ease of use.

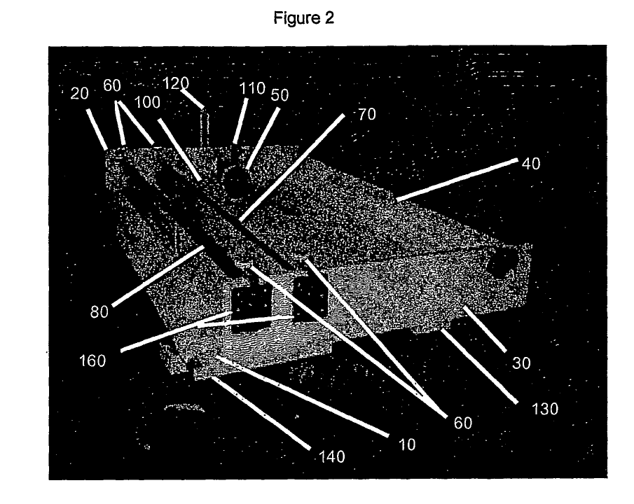

In FIG. 2, a right side perspective view of the present invention is shown. This is the user's view if the user is standing slightly above and to the right of the present invention. The bottom (10) of the invention is shown, as well as the left side (20) and right side (30). The wallpaper roll (40) is toward the right side of FIG. 2, with the counter (50) slightly to the left. The unrolled wallpaper (100) is shown extending from the wallpaper roll (40) left and under counter (50). Adjustment pieces (60) are disposed near left side (20) and right side (30) to control the height of a first adhesive swiper (70) and a second adhesive swiper (80).

The present invention is provided in three sizes for working with three common sizes of wallpaper. Specifically, the first embodiment of the present invention has left side (20) and right side (30) being 4 inches high and 24 inches long. The bottom (10) is a plate 11 inches wide and 25 inches long. Counter (50) is essentially a conventional rolling measuring device disposed on a support (110) and brace (120). Together, counter (50) and support (110) and brace (120) are 21½ inches long and 4 inches wide. A first support (130) and second support (140) are each 23 inches long and 4 inches wide, and disposed underneath bottom (10). First adhesive swiper (70) and a second adhesive swiper (80) are each 22¼ inches long and 3 inches high. Preferably, the all aforementioned pieces are fastened with a 1⅝ inch non-corrosive screw and PVC adhesive added for extra strength. Additionally, all the aforementioned pieces are ¾ inch polyethylene or engineering plastic. This embodiment weighs approximately 20 pounds.

Specifically, the second embodiment of the present invention has left side (20) and right side (30) being 4 inches high and 26 inches long. The bottom (10) is a plate 11 inches wide and 30 inches long. Counter (50) is essentially a conventional rolling measuring device disposed on a support (110) and brace (120). Together, counter (50) and support (110) and brace (120) are 28½ inches long and 4 inches wide. A first support (130) and second support (140) are each 30 inches long and 4 inches wide, and disposed underneath bottom (10). First adhesive swiper (70) and a second adhesive swiper (80) are each 24¼ inches long and 3 inches high. Preferably, the all aforementioned pieces are fastened with a 1⅝ inch non-corrosive screw and PVC adhesive added for extra strength. Additionally, all the aforementioned pieces are ¾ inch polyethylene or engineering plastic. This embodiment weighs approximately 26 pounds.

Specifically, the third embodiment of the present invention has left side (20) and right side (30) being 4½ inches high and 26 inches long. The bottom (10) is a plate 12 inches wide and 56 inches long. Counter (50) is essentially a conventional rolling measuring device disposed on a support (110) and brace (120). Together, counter (50) and support (110) and brace (120) are 54½ inches long and 4½ inches wide. A first support (130) and second support (140) are each 56 inches long and 4 inches wide, and disposed underneath bottom (10). First adhesive swiper (70) and a second adhesive swiper (80) are each 55¼ inches long and 3½ inches high. Preferably, the all aforementioned pieces are fastened with a 1⅝ inch non-corrosive screw and PVC adhesive added for extra strength. Additionally, all the aforementioned pieces are ¾ inch polyethylene or engineering plastic. This embodiment weighs approximately 46 pounds.

In each embodiment of the present invention the first adhesive swiper (70) and the second adhesive swiper (80) can be adjusted by adjustment pieces (60) to allow for separate thick nesses of wallpaper. In this manner the user may easily switch from a thin, non textured wallpaper to a thicker or textured wall paper without having to take the first swiper (70) and second swiper (80) off of the left (20) and right (30) sides of the invention.

The counter (50) in each embodiment of the present invention measure the amount of wallpaper which has extended from the wallpaper roll (40) and has paste applied. Each embodiment of the present invention can be equipped with a cutter (not shown) which can cut a length of wallpaper appropriate to the size needed in the current room. The cutter (not shown) could nbe a blade on a track at the end of the second swiper (80).

Additionally the present invention can be used to paper an entire room with only one worker. The worker can lay paste between the first (70) and second swiper (80) and pull the wall paper through the paste along the bottom (10). The worker may then stop the movement of the paper when the desired length, as shown by the counter (50) has been met. The user should then fold the paper once to touch adhesive side to adhesive side. The paper can then be cut by the cutting element (not shown). The user may then fold or roll the paper as desired, to easily handle a large section of paper by him or herself. The adhesive side to adhesive side fold ensures that the user will not paste the design side to the adhesive side of the paper. This method can be implemented because the paste will not permanently adhere to itself. The user may then move the large section of paper to the starting point on the wall, and paper the wall in a conventional manner.

Various accessories are available for the embodiments of the present invention, including a conventional counter support plate (not shown), conventional corner bracket support plates (160); flaps (not shown) disposed near wallpaper roll (40) to protect the metal bar (not shown) within wallpaper roll (40); conventional rubber ends (not shown) /033481 added to the ends of first adhesive swiper (70) and second adhesive swiper (80) to prevent friction between unrolled wallpaper (100) and first adhesive swiper (70) and second adhesive swiper (80); aluminum cormers mounted in front of bottom (10) to assist in simple slashing of unrolled wallpaper (100) from the present invention.

The present invention is not limited to the sole embodiments described above, but includes any and all embodiment in the following claims.

1. A device for pasting wallpaper, comprising:
a main body member;
a means for receiving a wallpaper roll, disposed on said main body member;
a first vertical member for containing adhesive, disposed within said main body member;
a second vertical member for containing adhesive disposed within said main body member.

2. The device of claim 1, further comprising a counter in communication with said main body member.

3. The device of claim 1, further comprising two adjustment pieces in communication with said first vertical member for containing adhesive.

4. The device of claim 1, wherein said two adjustment pieces are in communication with said second vertical member for containing adhesive.

5. The device of claim 1, further comprising a workbench disposed underneath said main body member.

6. The device of claim 1, wherein said adjustment pieces are configured to prevent adhesive from moving backwards on said main body member.

7. The device of claim 1, wherein said two adjustment pieces are configured to accommodate different thicknesses of wallpaper.

8. The device of claim 1, wherein each of said two adjustment pieces have a knob that a user can turn with the user's hand to adjust the height of said first vertical member and said second vertical member.

9. The device of claim 1, wherein said main body member is configured to be three various sizes dependent upon the wallpaper-pasting needs of the user.
